(19) United States
(12) Patent Application Publication
(10) Pub. No.: US 2019/0252092 A1
(43) Pub. Date: Aug. 15, 2019

(54) WIRE HARNESS AND METHOD OF MANUFACTURING WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Housei MIZUNO, Mie (JP); Makoto HIGASHIKOZONO, Mie (JP); Satoshi YAMAMOTO, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 16/342,427

(22) PCT Filed: Oct. 18, 2017
(86) PCT No.: PCT/JP2017/037615

§ 371 Date: Apr. 16, 2019

(30) Foreign Application Priority Data
Nov. 7, 2016 (JP) 2016-217071

(51) Int. Cl. H01B 7/00; H01B 13/012; B60R 16/02

(52) U.S. Cl. CPC H01B 7/0045; B60R 16/0215; H01B 13/01209

(57) ABSTRACT

The present invention provides a technology that is capable of constraining a reduction that occurs in the vicinity of a branch portion in the degree of freedom of electrical wires that extend from the branch portion. A wire harness includes a wire harness main body in which a plurality of electrical wires are wired while forming a branch portion; and a sheet member that is mounted on an exterior of the wire harness main body. The sheet member includes a sheet main body that is kept in an overlapping state where the sheet main body sandwiches a region that includes the branch portion and portions in crotches on the periphery of the branch portion, and the sheet member has an incision that reaches an outer edge from an interior of the sheet main body formed at portions of the sheet main body positioned at the portions in the crotches.

### FIELD OF THE INVENTION

The present invention relates to a technology that bundles a branch portion of a wire harness.

### BACKGROUND OF THE INVENTION

Patent Literature 1, Patent Literature 2, and Patent Literature 3 disclose technologies that regulate a path and protect a branch portion of a wire harness by sandwiching the branch portion between sheet members.

Specifically, in Patent Literature 1, path regulation is performed by sandwiching a region that comprises the majority of an electrical wire between two rectangular laminate films. Also, in Patent Literature 2, similar to Patent Literature 1, path regulation is performed by sandwiching a region that comprises the majority of an electrical wire between two rectangular laminate films, and further cuts away a portion of the laminate film that is at a crotch. Also, in Patent Literature 3, a technology is disclosed which maintains a shape of a wire harness by sandwiching a region that comprises the majority of the wire harness and includes a branch portion between single-sided adhesive sheets formed in a shape corresponding to the shape of the wire harness.

### RELATED ART

### Patent Literature

Patent Literature 1: Japanese Patent Laid-open Publication No. 2012-099301

Patent Literature 2: Japanese Patent Laid-open Publication No. 2012-155991

Patent Literature 3: Japanese Patent Laid-open Publication No. 2012-161234

### SUMMARY OF THE INVENTION

### Problems to be Solved by the Invention

However, in the technology described in Patent Literature 1, the laminate films exist up to a portion in the crotch between the branched wires, and therefore there is a risk that the degree of freedom of the electrical wires that extend from the branch portion may be reduced in the vicinity of the branch portion. In addition, in the technology described in Patent Literature 2, an incision must be provided in at least two places in the crotches when cutting away the laminate film after the film has been applied, and there is a risk that the electrical wires may be damaged by creating the incision in a position near the electrical wires. Also, in the technology described in Patent Literature 3, single-sided adhesive sheets are used in which the portion in the crotch is cut away ahead of time, before the sheet has been applied, and thus the shape of the single-sided adhesive sheets is complex and exacting alignment is required. Therefore, the workability involved in applying a sheet member deteriorates.

Given the above, the present invention provides a technology that is capable of constraining a reduction that occurs in the vicinity of the branch portion in the degree of freedom of the electrical wires that extend from the branch portion, and can also constrain damage to the electrical wires at that time and deterioration in attachment workability of a sheet member.

### Means for Solving the Problems

In order to resolve the above issues, a wire harness according to a first aspect includes a wire harness main body in which a plurality of electrical wires are wired while forming a branch portion; and a sheet member that includes a sheet main body that is kept in an overlapping state where the sheet main body sandwiches a region that includes the branch portion and portions in crotches on the periphery of the branch portion, the sheet member having an incision that reaches an outer edge from an interior of the sheet main body formed at portions of the sheet main body positioned at the portions in the crotches.

A wire harness according to a second aspect is the wire harness according to the first aspect, where a through-hole that communicates with an end portion of the incision on the interior side of the sheet main body is formed in the sheet member.

A wire harness according to a third aspect is the wire harness according to one of the first and second aspects, where a protective member that protects a branched wire is mounted on an exterior of at least one of a plurality of branched wires that extend from the branch portion, and an outer edge of the sheet member is overlaid on an outer circumference of the protective member.

A wire harness according to a fourth aspect is the wire harness according to any one of the first to third aspects, where the sheet member has the wire harness main body sandwiched between two separately provided sheet main bodies.

A wire harness according to a fifth aspect is the wire harness according to the first to third aspects, where the sheet member sandwiches the wire harness main body therebetween by folding a single sheet main body at a middle portion.

A wire harness according to a sixth aspect is the wire harness according to the fifth aspect, where a plurality of the branch portions are provided, and in one of two adjacent branch portions, the branched wire extends on a first side of a main line, and in the other the branched wire extends on a second side of the main line, and the two adjacent branch portions are respectively covered by two sheet main bodies that are folded in reverse orientations.

A wire harness according to a seventh aspect is the wire harness according to any one of the first to sixth aspects, where the plurality of branched wires extend in a comb-tooth shape.

A method of manufacturing a wire harness according to an eighth aspect includes (a) a process of wiring a plurality of electrical wires while forming a branch portion; (b) a process of maintaining an overlapping state where a sheet main body sandwiches a region that includes the branch portion and portions in crotches on the periphery of the branch portion; and (c) a process of forming an incision that reaches an outer edge from an interior of the sheet main body formed at portions of the sheet main body positioned at the portions in the crotches.

A method of manufacturing a wire harness according to a ninth aspect is the method of manufacturing the wire harness according to the eighth aspect, where the process (c) includes (c1) a process where perforations are formed in the sheet main body; and (c2) a process where, after the process (c1), the perforations are torn to form the incision.

### Effect of the Invention

According to the first to seventh aspects, the incisions that reach the outer edge from the interior of the sheet main body are formed at the portions of the sheet main body in the crotches. Therefore, a reduction that occurs in the vicinity of the branch portion in the degree of freedom of the electrical wires that extend from the branch portion can be constrained. At this time, because the incision is an incision, the incision can be provided at a position far from the electrical wires. Accordingly, even when the incision is created after the sheet main body is attached to the wire harness main body, the electrical wires are unlikely to be damaged. In addition, even when the incision is created before the sheet main body is attached to the wire harness main body, the shape is unlikely to be complex as compared to a case of cutting away, and therefore aligning positions when overlaying members is facilitated. Given the above, a reduction that occurs in the vicinity of the branch portion in the degree of freedom of the electrical wires that extend from the branch portion can be constrained, and also damage to the electrical wires at that time and deterioration in attachment workability of the sheet member can be constrained.

In particular, according to the second aspect, by providing the through-hole at the end portion of the incision, the sheet main body is inhibited from tearing beginning at the end portion of the incision.

In particular, according to the third aspect, the protective member can be positioned using the sheet member.

In particular, according to the fourth aspect, the present invention can readily adapt even when the branched wires extend from both sides of the main line.

In particular, according to the fifth aspect, the work involved in applying a sheet member is facilitated.

In particular, according to the sixth aspect, the branched wires can easily be extended on both sides of the main line even with the folding-type sheet member.

In particular, according to the seventh aspect, there is no longer any need to concentrate the branching in one place.

According to the eighth and ninth aspects, the incisions that reach the outer edge from the interior of the sheet main body are formed at the portions of the sheet main body in the crotches. Therefore, a reduction that occurs in the vicinity of the branch portion in the degree of freedom of the electrical wires that extend from the branch portion can be constrained. At this time, because the incision is an incision, the incision can be provided at a position far from the electrical wires. Accordingly, even when the incision is created after the sheet main body is attached to the electrical wires, the electrical wires are unlikely to be damaged. In addition, even when the incision is created before the sheet main body is attached to the electrical wires, the shape of the sheet main body is unlikely to be complex as compared to a case where the sheet main body is cut away, and therefore aligning positions when overlaying members is facilitated. Given the above, a reduction that occurs in the vicinity of the branch portion in the degree of freedom of the electrical wires that extend from the branch portion can be constrained, and also damage to the electrical wires at that time and deterioration in attachment workability of the sheet member can be constrained.

In particular, according to the ninth aspect, by creating the perforations in the sheet main body ahead of time and later tearing the perforations, the incision can be formed easily. Also, because the incision can also be formed without using a blade, due to the shape of the perforations, the electrical wires are unlikely to be damaged even when the incision is created after attaching the sheet main body to the electrical wires.

### BRIEF DESCRIPTION OF THE DRAWINGS

FIG. 1 is a plan view illustrating a wire harness according to a first embodiment.

FIG. 2 is a cross-sectional view sectioned along a line II-II in FIG. 1.

FIG. 3 is a plan view illustrating a sheet member prior to attachment.

FIG. 4 is an explanatory diagram illustrating a phase where the wire harness according to the first embodiment is manufactured.

FIG. 5 is an explanatory diagram illustrating a phase where the wire harness according to the first embodiment is manufactured.

FIG. 6 is an explanatory diagram describing a phase where a sheet member is positioned.

FIG. 7 is an explanatory diagram illustrating a phase where the wire harness according to the first embodiment is manufactured.

FIG. 8 is a plan view illustrating a wire harness according to a second embodiment.

FIG. 9 is an explanatory diagram illustrating a phase where the wire harness according to the second embodiment is manufactured.

FIG. 10 is an explanatory diagram illustrating a phase where the wire harness according to the second embodiment is manufactured.

### MODE FOR CARRYING OUT THE INVENTION

### First Embodiment

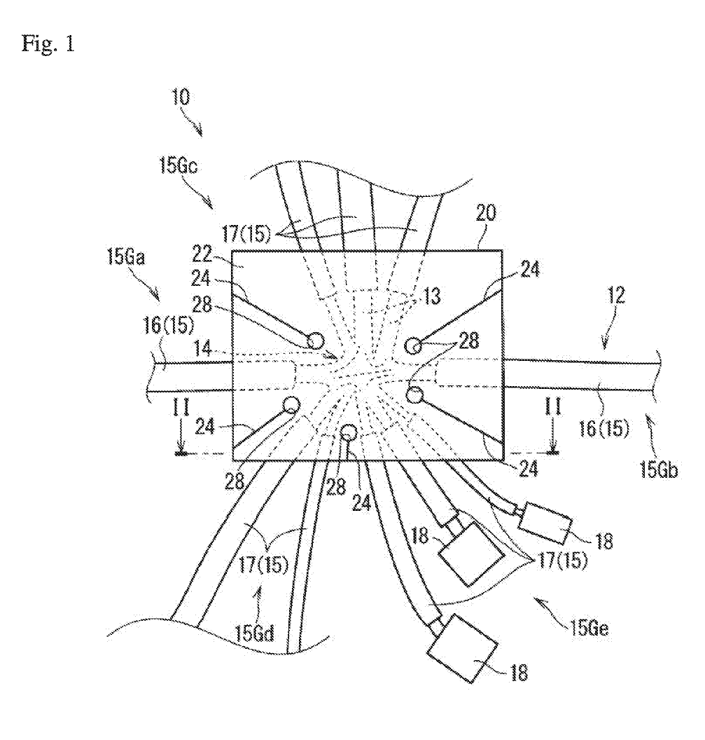

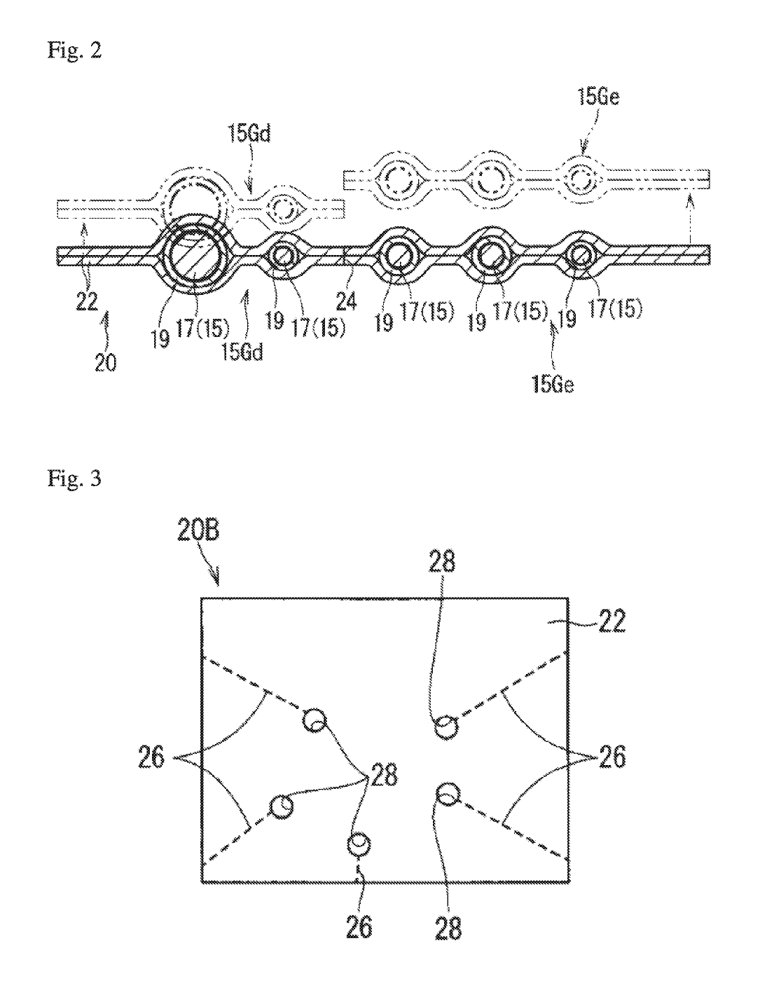

In the following, a wire harness according to a first embodiment is described. FIG. 1 is a plan view illustrating a wire harness 10 according to the first embodiment. FIG. 2 is a cross-sectional view sectioned along a line II-II in FIG. 1.

The wire harness 10 includes a branch portion 14. A sheet member 20 is attached to the branch portion 14. This allows path regulation, protection, and the like for the branch portion 14. Specifically, the wire harness 10 includes a wire harness main body 12 and the sheet member 20.

The wire harness main body 12 includes a plurality of electrical wires 13. Furthermore, in this example, the wire harness main body 12 includes a protective member 19.

The wire harness main body 12 has a plurality of connectors 18 connected via the plurality of electrical wires 13. More specifically, the wire harness main body 12 is configured by bundling the plurality of electrical wires 13 while forming the branch portion 14. End portions of the plurality of electrical wires 13 are inserted into and connected to the connectors 18 at the tip of each branch of the wire harness main body 12. In a state where the wire harness main body 12 is assembled with a vehicle, each connector 18 is connected to various kinds of electrical components installed in the vehicle. Accordingly, the wire harness main body 12 plays a role of electrically connecting the various kinds of electrical components installed in the vehicle. The plurality of electrical wires 13 may be bundled at an appropriate location with a bundling member such as adhesive tape or a bundling band, for example.

The protective member 19 is mounted on an exterior of at least one of a plurality of branched wires 15 that extend from the branch portion 14.

In this example, in the present specification, “branched wire 15” is used to designate a group of various electrical wires 13 that extend from the branch portion 14. At this time, the wire harness 10 ordinarily takes a form where a branch line 17 appropriately branches from an aggregate of many electrical wires 13 called a main line 16. In the present specification, the main line 16 and the branch line 17 are both a type of branched wire 15, and one of the branched wires 15 where a group of a particularly large number of electrical wires 13 is gathered is deemed to be the main line 16.

Therefore, the protective member 19 is mounted on the exterior of at least one of the branched wires 15, which includes the main line 16 and the branch lines 17, and protects the wire. In the example illustrated in FIG. 1, the protective member 19 is attached to all of the branched wires 15 extending from the branch portion 14.

The shape of such a protective member 19 is not particularly limited. For example, a corrugated tube in which a thick annular portion and a thin annular portion continue alternatingly along an axis center direction, or a tube where a uniform cross-section continues in the axis center direction, or the like can be used as the protective member 19. Also, a sheet-like member can be used as the protective member 19. In such a case, the sheet-like member may be wrapped around the electrical wire 13 in a manner where one outer edge is configured as a winding start portion and another outer edge is configured as a winding end portion, or the sheet-like member may be folded around at a middle portion such that one outer edge and another outer edge meet.

Such a protective member 19 covers a portion of the branched wire 15 that includes a region that runs from a position near the branch portion 14 to a terminal. The protective member 19 preferably covers up to a position near the terminal.

Next, the sheet member 20 is described with reference to FIG. 3 in addition to FIGS. 1 and 2. FIG. 3 is a plan view illustrating a sheet member 20B prior to attachment.

The sheet member 20 covers the branch portion 14 as noted above. The sheet member 20 includes a sheet main body 22. In addition, an incision 24 is made in the sheet main body 22. Furthermore, a through-hole 28 is formed in the sheet main body 22.

The sheet main body 22 is kept in an overlapping state on either side of a region that includes the branch portion 14 and portions in crotches on the periphery of the branch portion 14. In this example, a single branch portion 14 of the wire harness main body 12 is sandwiched between two separately provided sheet main bodies 22. The sheet main bodies 22 may be formed uniformly with, for example, a resin such as polyvinyl chloride (PVC) or polypropylene (PP) as their material. Also, a nonwoven fabric such as a spunbond nonwoven fabric may be adopted, for example.

A retention mechanism for keeping the two sheet main bodies 22 in an overlapped state is not particularly limited. However, the retention mechanism is preferably capable of bonding inner surfaces of the facing and in-contact sheet main bodies 22 with each other. Examples of this sort of retention mechanism may include double-sided adhesive tape, an adhesive agent, or the like. In such a case, the sheet main bodies 22 are bonded with each other, which does not necessarily require that the sheet main bodies 22 and the wire harness main body 12 be bonded together. In addition, in such a case, the double-sided adhesive tape or adhesive material is favorably provided to the sheet main bodies 22 ahead of time. Also, a self-adhesive material can also be used as the retention mechanism, for example. In such a case, using a sheet member 20 provided with a self-adhesive material results in a state where the sheet main bodies 22 are bonded to each other while the sheet main bodies 22 and the wire harness main body 12 are not bonded together. In addition, the retention mechanism may also be welding or the like.

As noted above, the sheet main bodies 22 are kept in an overlapping state on either side of the region that includes the branch portion 14 and the portions in the crotches on the periphery of the branch portion 14. At this time, the outer edges of the sheet main bodies 22 overlap on an outer circumference side of the protective members 19. In other words, the protective members 19 extend to a region inside the overlapping sheet members 20. Accordingly, positioning of the protective members 19 along an extension direction of the branched wire 15 can be achieved. The sheet main bodies 22 and the protective members 19 are not necessarily bonded together by the retention mechanism.

The incision 24 is formed at a portion of the sheet main body 22 that is positioned at the portion in a crotch. The incision 24 reaches the outer edge from the interior of the sheet main body 22. Which space between each of the branched wires 15 has an incision 24 provided thereto may be set as appropriate. The incision 24 is preferably provided to all the spaces between each of the branched wires 15. However, at locations where the branched wires 15 are crowded together, there may be cases where it is difficult to provide an incision 24 to all the spaces between each of the branched wires 15. In such a case, the incision 24 is preferably provided so as to enable partitioning each branched wire group 15G in which a terminal portion is connected to a nearby position in the vehicle. In addition, when assembling the wire harness 10 to the vehicle, this may take the form of fixating the main line 16 first, and then moving and fixating the branch lines 17. In such a case, when the incision 24 is made in the portion in the crotch defined by the main line 16, fixating the main line 16 and moving the branch line 17 is readily done.

In the example illustrated in FIG. 1, five incisions 24 are provided, and ten branched wires 15 extending from a single branch portion 14 are partitioned into five branched wire groups 15G. Of these, two branched wire groups 15Ga and 15Gb are configured by the main line 16 extending in opposite directions, and the remaining three branched wire groups 15Gc, 15Gd, and 15Ge are configured by the branch lines 17. More specifically, on one side of the main line 16, three branch lines 17 extending from the branch portion 14 form the single branched wire group 15Gc. In addition, on the other side of the main line 16, three branch lines 17 of the five branch lines 17 extending from the branch portion 14 form the single branched wire group 15Gd, and the remaining two branch lines 17 form the separate branched wire group 15Ge.

Due to the presence of the incisions 24, each of the branched wire groups 15G becomes capable of extending in a mutually different direction even in a region that is covered by the sheet member 20, as illustrated by imaginary lines (two dot dashed lines) in FIG. 2. At this time, the incisions 24 are provided so as to enable partitioning each branched wire group 15G in which a terminal portion is connected to a nearby position in the vehicle, whereby, in a branched wire group 15G that includes a plurality of branched wires 15, when the terminal portion of one branched wire 15 is moved, the other branched wires 15 in that branched wire group 15G also move so as to follow that movement. Therefore, even in a case where there are a large number of branched wires 15 and a terminal portion is difficult to identify, a branched wire 15 that is connected to a position near the terminal portion of the branched wire 15 in question becomes more readily identifiable.

The position (direction) where the incision 24 is formed in the portion in the crotch is not particularly limited. The incision 24 may be formed centrally in the crotch, or may be formed at a position closer to one of the two branched wires 15 positioned on the two sides of the crotch. The incision 24 is preferably formed so as to pass through the center inside the crotch as much as possible. By doing so, a bonding surface area of the sheet main body 22 can be inhibited from becoming excessively small in the two side portions of the portion inside the crotch that are partitioned by the incision 24, and the sheet main bodies 22 can be inhibited from peeling away from each other. In addition, the electrical wires 13 may greatly separate and fly away from a proper course due to a defect or the like acquired during manufacture. Of such cases, and in particular even when a portion of the electrical wires 13 that configure one of the branched wires 15 of the crotch flies away toward the other branched wire 15 of the crotch, by having the incision 24 formed so as to pass through the center inside the crotch as much as possible, the flyaway electrical wires 13 can be inhibited from protruding from the sheet member 20.

The through-hole 28 is formed so as to communicate with an end portion of the incision 24 on the interior side of the sheet main body 22. In this example, the through-hole 28 is formed at the end portions of all five incisions 24. However, there may also be an incision 24 where the through-hole 28 is not formed. Also, in the example illustrated in FIG. 1, the through-hole 28 is formed in a circular hole shape, but this is not necessarily required, and other shapes such as an angular hole shape may be used. At this time, the through-hole 28 is favorably formed to a size that allows a rod-shaped jig to be inserted therethrough. Accordingly, the through-hole 28 can be used to position the sheet member 20B. This will be described in detail later.

In this example, perforations 26 are formed in the sheet member 20B prior to attaching the wire harness main body 12. The perforations 26 are formed at a position corresponding to the incision 24 and with a similar length dimension to the incision 24. Accordingly, the incision 24 is formed by tearing the perforations 26. At this time, the through-hole 28 is also formed in the pre-attachment sheet member 20B. The through-hole 28 is formed at a position at the end portion of the incision 24, as noted above. Therefore, in the sheet member 20B, the through-hole 28 is formed at a position at the end portion of the perforations 26. The through-hole 28 and the perforations 26 are favorably formed in conjunction by press processing or the like. For example, the through-hole 28 and the perforations 26 may be formed when a large-sized sheet base material is cut to obtain the sheet main body 22 having predetermined dimensions, or the like.

### Manufacturing Method

Next, a manufacturing method of the wire harness 10 is described.

First, two sheet members 20B are prepared on which the perforations 26 and the through-holes 28 as illustrated in FIG. 3 are formed.

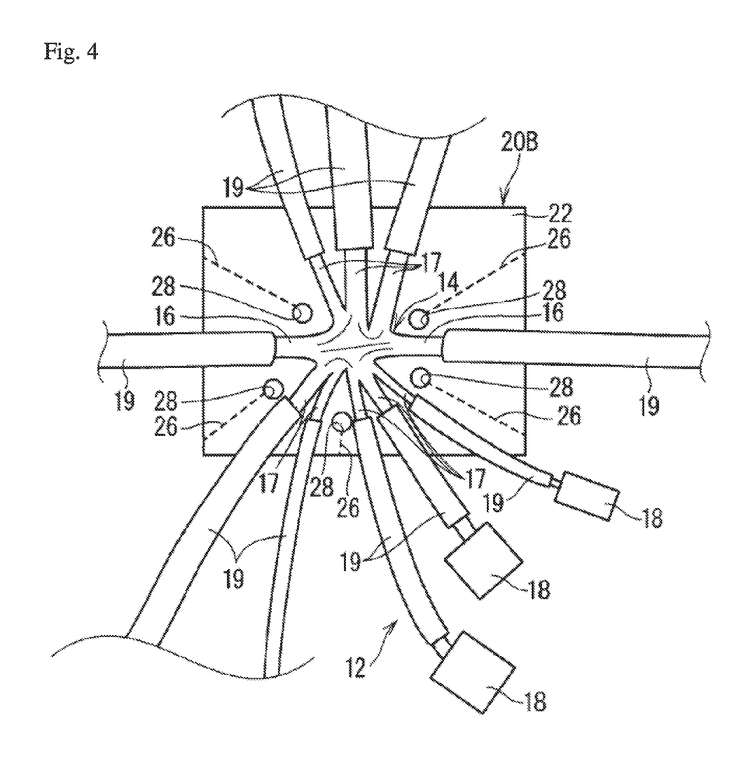

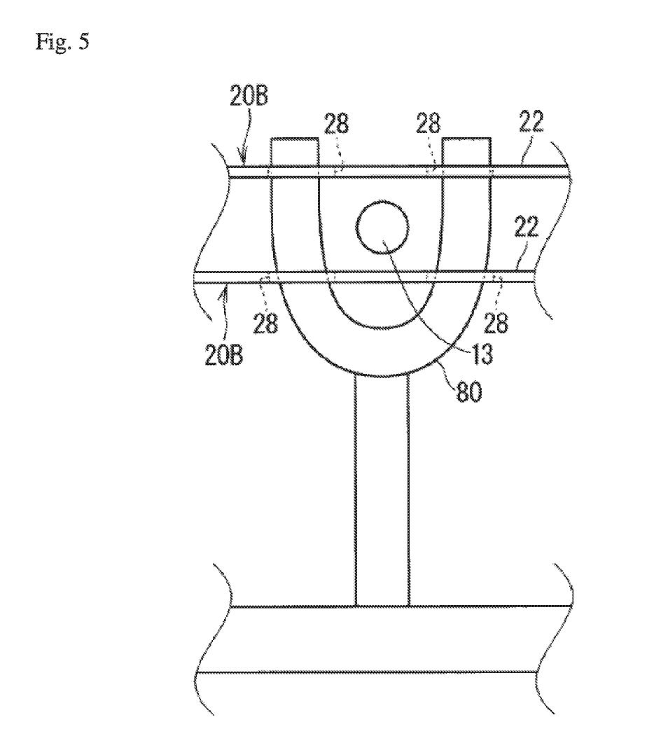

Next, the plurality of electrical wires 13 are wired while forming the branch portion 14. In this example, as illustrated in FIG. 4, the plurality of electrical wires 13 are arranged above a first sheet member 20B. At this time, as illustrated in FIG. 5, the rod-shaped jig 80 is favorably inserted through the through-holes 28 formed in the sheet main body 22 and positions the sheet member 20B. A jig 80 called a U jig that is formed in a “U” shape and is capable of supporting the electrical wire 13 inside the “U” may be used as this jig 80, for example.

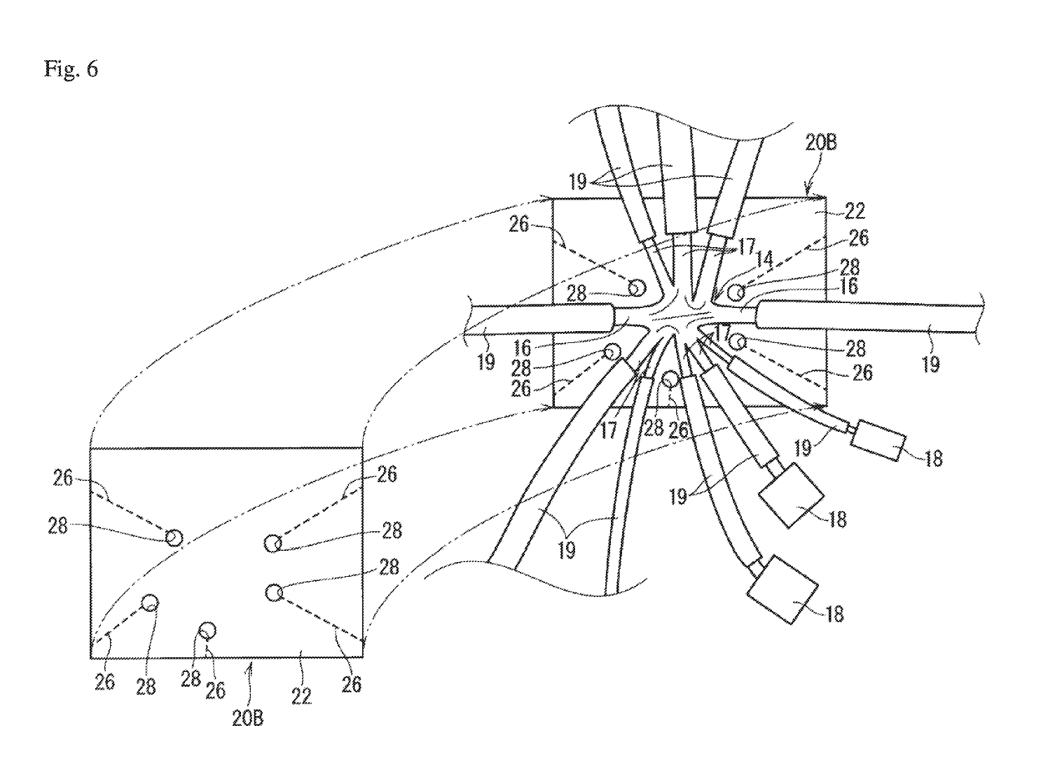

Next, the region that includes the branch portion 14 and the portions in the crotches on the periphery of the branch portion 14 is sandwiched between the sheet main bodies 22, which are kept in an overlapping state. More specifically, as illustrated in FIG. 6, a second sheet member 20B is overlaid above the first sheet member 20B and the electrical wires 13, which are positioned above the first sheet member 20B. At this time, the sheet member 20B has a square shape and the incisions 24 are not yet formed, and therefore alignment of the two sheet members 20B is completed simply by aligning the four corners of the sheet members 20B. Also, at this point, when the jig 80 is inserted through the through-holes 28 of the first sheet member 20B, the two sheet members 20B can also be roughly aligned by overlaying the second sheet member 20B on the first sheet member 20B and the electrical wires 13 such that the jig 80 is also inserted through the through-holes 28 of the second sheet member 20B. Moreover, by inserting the jig 80 through the through-holes 28, the position of the sheet member 20B is unlikely to deviate in a direction of principal surface spread.

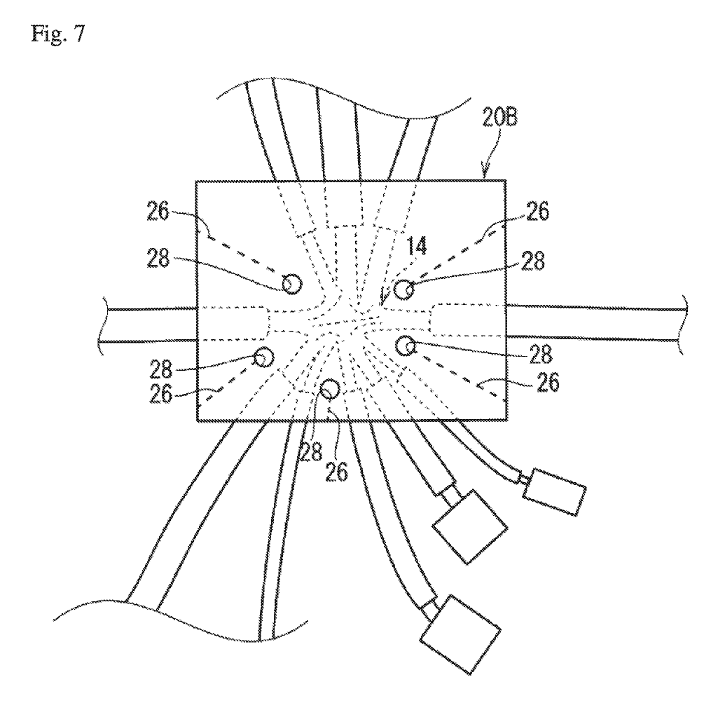

When the two sheet members 20B overlap each other at an appropriate position, the outer edge of the sheet main body 22, the perforations 26, and the through-holes 28 are in an overlapping state, as in FIG. 7. In this state, the overlapping state of the two sheet members 20B is maintained by the retention mechanism noted above, such as an adhesive agent.

Next, the incisions 24 that reach the outer edge from the interior of the sheet main body 22 are formed at portions of the sheet main body 22 that are positioned at the portions in the crotches. In this example, the incisions 24 are formed by tearing the perforations 26 which are formed in advance on the sheet main body 22. The perforations 26 may be torn from the outer edge side, or may be torn from the through-hole 28 side. When tearing the perforations 26 from the outer edge side, the through-hole 28 is at the end portion of the perforations 26 and therefore even when tearing energetically, the sheet main body 22 is unlikely to tear up to a region past the position of the through-hole 28. In addition, the perforations 26 may be difficult to identify due to the shape of the perforations 26, or due to the surface shape of the sheet main body 22. Even in such cases, when there is a through-hole 28 that is formed to be larger than the small divots that configure the perforations 26, the perforations 26 are more readily identifiable using the through-hole 28 as an indicator.

The wire harness 10 illustrated in FIG. 1 is completed by attaching the sheet main body 22 to the region that includes the branch portion 14 of the wire harness main body 12 and forming the incisions 24 in the sheet main body 22.

According to the wire harness 10 and method of manufacturing the same, the incisions 24 that reach the outer edge from the interior of the sheet main body 22 are formed at the portions of the sheet main body 22 in the crotches. Therefore, a reduction that occurs in the vicinity of the branch portion 14 in the degree of freedom of the electrical wires 13 that extend from the branch portion 14 can be constrained. At this time, because the incision 24 is an incision, the incision 24 can be provided at a position far from the electrical wires 13. Accordingly, even when the incision 24 is created after the sheet main body 22 is attached to the wire harness main body 12, the electrical wires 13 are unlikely to be damaged. In addition, even when the incision 24 is created before the sheet main body 22 is attached to the wire harness main body 12, the shape is unlikely to be complex as compared to a case of cutting away, and therefore aligning the positions when overlaying the members is facilitated. Given the above, a reduction that occurs in the vicinity of the branch portion 14 in the degree of freedom of the electrical wires 13 that extend from the branch portion 14 can be constrained, and also damage to the electrical wires 13 at that time and deterioration in attachment workability of the sheet member 20B can be constrained.

In addition, by providing the through-hole 28 at the end portion of the incision 24, the sheet main body 22 is inhibited from tearing beginning at the end portion of the incision 24.

Also, by overlaying the outer edge of the sheet member 20 on the protective members 19, the protective members 19 can be positioned using the sheet member 20.

In addition, by sandwiching the branch portion 14 between the two sheet members 20B, the present invention can readily adapt even when the branched wires 15 extend from both sides of the main line 16.

Furthermore, by creating the perforations 26 in the sheet main body 22 ahead of time and later tearing the perforations 26, the incision 24 can be formed easily. Also, because the incision 24 can also be formed without using a blade, due to the shape of the perforations 26, the electrical wires 13 are unlikely to be damaged even when the incision 24 is created after attaching the sheet main body 22 to the electrical wires 13.

### Second Embodiment

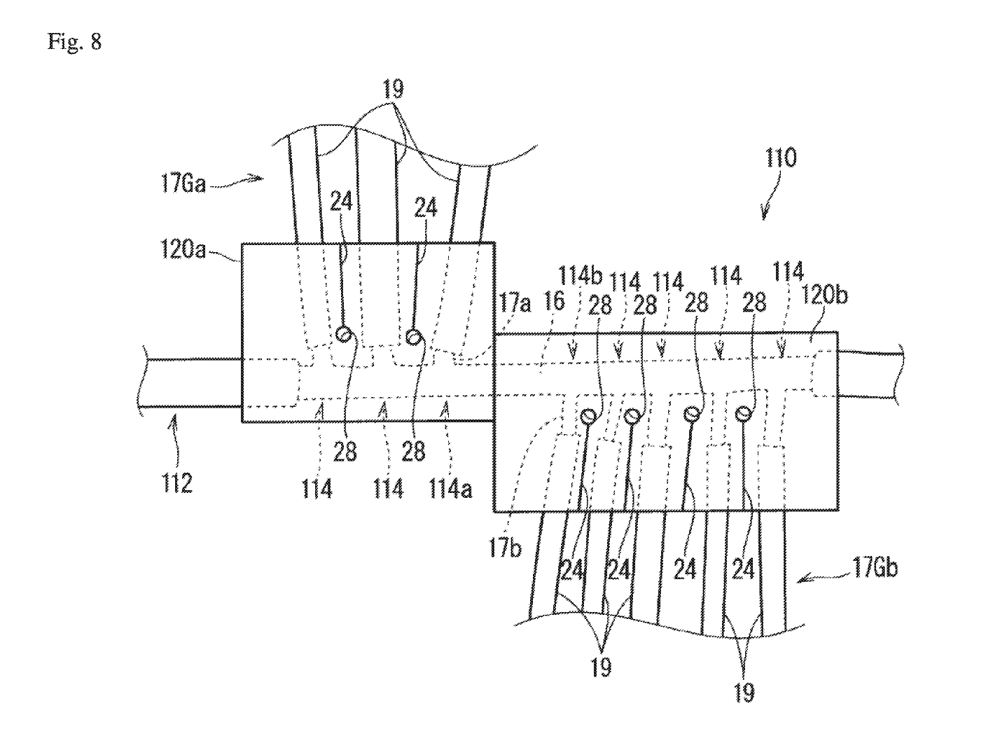

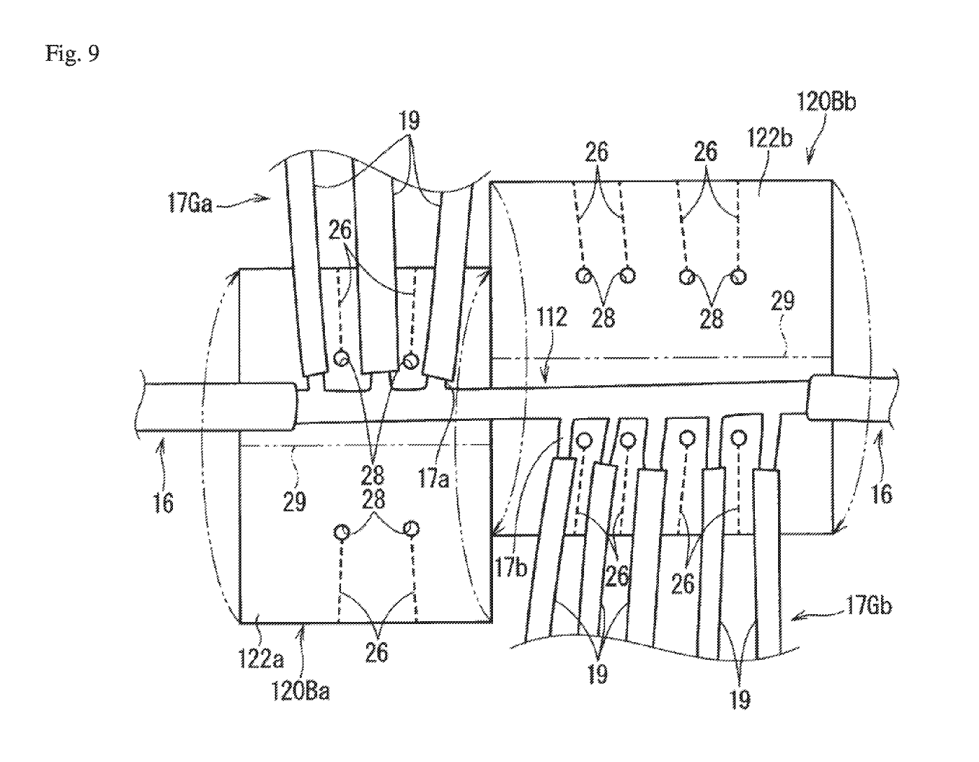

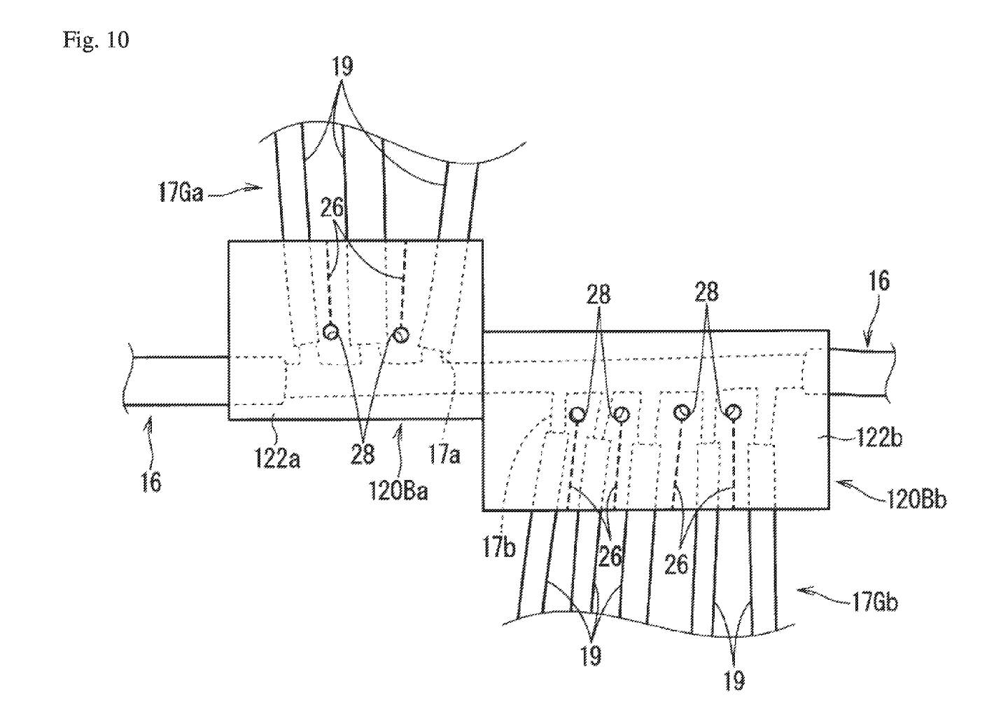

Next, a description is given of a wire harness according to a second embodiment. FIG. 8 is a plan view illustrating a wire harness 110 according to the second embodiment. FIGS. 9 and 10 are explanatory diagrams illustrating a phase where the wire harness 110 according to the second embodiment is manufactured. In the description of the present embodiment, configuration elements that are similar to those described previously are assigned the same reference numerals and the description thereof is omitted.

The wire harness 110 according to the second embodiment differs from the wire harness 10 according to the first embodiment in the shape of a branch portion 114 in a wire harness main body 112, and in that the branch portion 114 is covered by folding a single sheet member 120B.

A plurality of the branch portions 114 are provided in the wire harness main body 112. More specifically, the branch lines 17 branch from the main line 16 at a plurality of positions. In this case, one branch line 17 branches from each branch portion 114. That is, one branch line 17 at a time branches from the main line 16 with an interval therebetween along an extension direction of the main line 16. However, there may also be a branch portion where two or more branch lines 17 branch off.

This example includes branch portions 114a and 114b, where in one of the two adjacent branch portions 114, the branched wire 15 extends on a first side of the main line 16, and in the other the branched wire 15 extends on a second side of the main line 16. Moreover, in this example, in a group of branch portions 114, the plurality of branched wires 15 extend in a comb-tooth shape.

More specifically, the plurality of branch lines 17 are configured by two branch line groups 17Ga and 17Gb. The branch line group 17Ga all extend in the same direction (first side direction) with respect to the main line 16 on a first side along the extension direction of the main line 16. The branch line group 17Gb all extend in the same direction (second side direction) with respect to the main line 16 on a second side along the extension direction of the main line 16. Therefore, two adjacent branch lines 17a and 17b that are near the boundary between the branch line group 17Ga and the branch line group 17Gb extend in opposite directions from each other with respect to the main line 16. Also, the branch line group 17Ga and the branch line group 17Gb each extend in a comb-tooth shape with respect to the main line 16.

The wire harness main body 112 is sandwiched between the sheet member 120 by folding a single sheet main body 122 at a middle portion. In particular, in this example, a single sheet member 120Ba is folded and covers a region of the branch line group 17Ga that includes the branch portion 114. Also, a different single sheet member 120Bb is folded and covers a region of the branch line group 17Gb that includes the branch portion 114. At this time, the two adjacent branch portions 114a and 114b where the branched wires 15 (branch lines 17a and 17b) extend in reverse orientations from each other are respectively covered by the two sheet members 120Ba and 120Bb (sheet main bodies 122a and 122b) that are folded in reverse orientations.

When the branched wires 15 extend in the comb-tooth shape, the portion in the crotch can more readily be made comparatively wider. Therefore, the incision 24 can be more readily provided to all the portions in the crotches. In addition, the protective member 19 can extend to a position near a base end of the branched wire 15. Accordingly, the end portion of the incision 24 can be extended back to a position near the main line 16 while setting the end portion of the incision 24 in a portion between the protective members 19, as with the portion that is covered by the sheet member 120Ba. In a region where the electrical wires 13 are sheathed in the protective members 19, the electrical wires 13 are inhibited from flying away. Therefore, when the end portion of the incision 24 is set in the portion between the protective members 19, the protective members 19 are in the regions to the side of the incision 24, therefore creating a state where the electrical wires 13 are inhibited from flying away, and inhibiting the electrical wires 13 from protruding from the sheet member 120, and the like.

In this way, when the single sheet member 120B is folded and covers the branch portion 114, the perforations 26 and through-hole 28 are formed at positions on each sheet member 120B that are symmetrical with respect to the position that forms a fold line 29 (see the imaginary line in FIG. 9). The fold line 29, an identifying line indicating the fold line 29, or the like may also be provided to the sheet member 120B ahead of time. In such a case, the work of folding the sheet member 120B is facilitated.

In order to manufacture the wire harness 110 described above, similar to when manufacturing the wire harness 10 of the first embodiment, first the electrical wires 13 are wired over the sheet member 120B while creating branches. In this state, as illustrated in FIG. 9, the sheet member 120B is folded and the sheet main body 122 overlaps. At this time, alignment can be accomplished simply by aligning one outer edge, and therefore alignment is facilitated as compared to overlapping two separate sheet members 20.

When the sheet main body 122 is overlapped on itself, FIG. 10 results. Afterward, similar to when manufacturing the wire harness 10 of the first embodiment, the perforations 26 are torn to form the incision 24 while the overlapping state of the sheet main body 122 is maintained by the retention mechanism. This completes the wire harness 10 illustrated in FIG. 8.

According to the wire harness 110 and method of manufacturing the same, the single sheet member 120B is folded to cover the branch portion 114, and therefore the work involved in overlapping the sheet main body 122 is facilitated.

In addition, the branched wires 15 extend in reverse orientations from each other at the two adjacent branch portions 114a and 114b, and also each of the branch portions 114a and 114b are covered by the sheet members 120a and 120b that are folded in reverse orientations. Therefore, the branched wires 15 can easily be extended on both sides of the main line 16 even with the folding-type sheet member 120.

In addition, the branched wires 15 extend from the main line 16 in the comb-tooth shape, and therefore there is no longer any need to concentrate the branching in one place. This increases the degree of freedom in designing each branched wire 15. Also, there is no longer any need to detour each branched wire 15 so as to pass through the branch portion 14, and therefore the present invention can be made more lightweight and costs can be reduced.

### Modifications

In the first embodiment and the second embodiment, a description is provided where the protective member 19 is mounted on the exterior of at least one branched wire 15, and the outer edge of the sheet member 20 is overlaid on the protective member 19. However, this is not strictly necessary. For example, the protective member 19 may not be mounted on the exterior of all of the branched wires 15 or, even when a branched wire 15 does have the protective member 19 mounted on the exterior thereof, the outer edge of the sheet member 20 may not be overlaid on the protective member 19.

Also, in the first embodiment and the second embodiment, a description is provided where the through-hole 28 is formed at the end portion of the incision 24. However, this is not strictly necessary. The through-hole 28 may also not be formed at the end portion of the incision 24.

In addition, in the first embodiment and the second embodiment, a description is provided where the perforations 26 are torn to form the incision 24. However, this is not strictly necessary. The incision 24 may also be formed directly, without providing the perforations 26. In such a case, the incision 24 may also be formed prior to overlapping the sheet main body.

Also, in the second embodiment, a description is provided where the branch line group 17Ga and the branch line group 17Gb are covered by separate sheet members 120a and 120b. However, this is not strictly necessary. The branch line group 17Ga and the branch line group 17Gb may also be covered by a single sheet member. In such a case, for example, by forming a slit at a boundary on the single sheet member between the portion that covers the branch line group 17Ga and the portion that covers the branch line group 17Gb, where the slit is oriented from two outer edges toward a middle portion while the middle portion is connected, the portion that covers the branch line group 17Ga and the portion that covers the branch line group 17Gb can be folded in reverse orientations.

Each configuration described in each of the above embodiments and modifications can be combined as appropriate so long as they do not contradict each other. For example, two separate sheet members 20 may also be overlapped in a region that includes the branched wires 15 extending in the comb-tooth shape. In addition, for example, a single sheet member 120 may also be folded and overlapped on a region that includes a plurality of branched wires 15 that extend from a single branch portion 14 in a rib shape that configures a fan.

In the above, the present invention is described in detail. However, the above description is, in all aspects, for exemplary purposes and the present invention is not limited thereto. Numerous modifications not given as examples are understood to be conceivable without departing from the scope of the present invention.

### DESCRIPTION OF REFERENCE NUMERALS

10 Wire harness
12 Wire harness main body
13 Electrical wire
14 Branch portion
15 Branched wire
15Ga, 15Gb Branched wire group
16 Main line
17 Branch line
17Ga, 17Gb Branch line group
18 Connector
19 Protective member
20 Sheet member
22 Sheet main body
24 Incision
26 Perforation
28 Through-hole
29 Fold line

1. A wire harness comprising:
a wire harness main body in which a plurality of electrical wires are wired while forming a branch portion; and
a sheet member that includes a sheet main body that is kept in an overlapping condition in which the sheet main body sandwiches a region that includes the branch portion and portions in crotches on the periphery of the branch portion, the sheet member having an incision that reaches an outer edge from an interior of the sheet main body formed at portions of the sheet main body positioned at the portions in the crotches.

2. The wire harness according to claim 1, wherein a through-hole that communicates with an end portion of the incision on the interior side of the sheet main body is formed in the sheet member.

3. The wire harness according to claim 1, wherein a protective member that protects a branched wire is mounted on an exterior of at least one of a plurality of branched wires that extend from the branch portion, and
an outer edge of the sheet member is overlaid on an outer circumference of the protective member.

4. The wire harness according to claim 1, wherein the sheet member has the wire harness main body sandwiched between two separately provided sheet main bodies.

5. The wire harness according to claim 1, wherein the sheet member sandwiches the wire harness main body therebetween by folding a single sheet main body at a middle portion.

6. The wire harness according to claim 5, wherein a plurality of the branch portions are provided,
in one of two adjacent branch portions, the branched wire extends on a first side of a main line, and in the other the branched wire extends on a second side of the main line, and
the two adjacent branch portions are respectively covered by two sheet main bodies that are folded in reverse orientations.

7. The wire harness according to claim 1, wherein the plurality of branched wires extend in a comb-tooth shape.

8. A method of manufacturing a wire harness comprising:
wiring a plurality of electrical wires while forming a branch portion;
maintaining an overlapping condition in which a sheet main body sandwiches a region that includes the branch portion and portions in crotches on the periphery of the branch portion; and
forming an incision that reaches an outer edge from an interior of the sheet main body formed at portions of the sheet main body positioned at the portions in the crotches.

9. The method of manufacturing the wire harness according claim 8, wherein forming the incision comprises:
forming perforations in the sheet main body; and
tearing the perforations to form the incision.
